(19) United States
(12) Patent Application Publication
(10) Pub. No.: US 2025/0130765 A1
(43) Pub. Date: Apr. 24, 2025

(54) DATA PROCESSING METHOD AND DEVICE

(71) Applicant: Smarter Silicon (Shanghai) Technologies Co., Ltd., Shanghai (CN)

(72) Inventor: Yong CHEN, Shanghai (CN)

(21) Appl. No.: 18/917,382

(22) Filed: Oct. 16, 2024

(30) Foreign Application Priority Data
Oct. 19, 2023 (CN) 202311362392.1

(51) Int. Cl. G06F 5/01

(52) U.S. Cl. CPC G06F 5/01

(57) ABSTRACT

A data processing method includes obtaining to-be-processed data and a target weight, based on the target weight, obtaining at least one target shift number, target shift numbers including all or a part of values of the valid value sequences, and performing a first strategy and obtaining a processing result of the to-be-processed data based on an obtained second shift result. The target weight includes a plurality of sets of valid number sequences, and after an initial weight is quantized into a sum of a plurality of powers of 2s, values of the sets of valid value sequences are power values of the plurality of powers of 2s.

### CROSS-REFERENCE TO RELATED APPLICATION

The present disclosure claims priority to Chinese Patent Application No. 202311362392.1, filed on Oct. 19, 2023, the entire content of which is incorporated herein by reference.

### TECHNICAL FIELD

The present disclosure is related to the data processing technology field and, more particularly, to a data processing method and a data processing device.

### BACKGROUND

The multiplication operation is a primary computational operation in neural networks. However, the execution process of the multiplication operation is relatively complex. A large number of computational circuits need to be deployed during the execution process. Thus, the multiplication operation in the neural networks consumes a large portion of resources, which increases the cost of model training or inference processes.

### SUMMARY

An aspect of the present disclosure provides a data processing method. The method includes obtaining to-be-processed data and a target weight, based on the target weight, obtaining at least one target shift number, target shift numbers including all or a part of values of the valid value sequences, and performing a first strategy and obtaining a processing result of the to-be-processed data based on an obtained second shift result. The target weight includes a plurality of sets of valid number sequences, and after an initial weight is quantized into a sum of a plurality of powers of 2s, values of the sets of valid value sequences are power values of the plurality of powers of 2s. The first strategy includes, based on a maximum shift number of a single shift operation supported by hardware, dividing the target shift numbers into a common shift number and individual shift numbers, performing addition after performing first-level shifting on the to-be-processed data with the plurality of individual shift numbers to obtain a first shift result, and performing second-level shifting on the first shift result according to the common shift number to obtain the second shift result.

An aspect of the present disclosure provides a data processing device including a first acquisition unit, a second acquisition unit, and a processing unit. The first acquisition unit is configured to obtain to-be-processed data and a target weight. The target weight includes a plurality of sets of valid number sequences, and after an initial weight is quantized into a sum of a plurality of powers of 2s, values of the sets of valid value sequences are power values of the plurality of powers of 2s. The second acquisition unit is configured to, based on the target weight, obtain at least one target shift number, target shift numbers including all or a part of values of the valid value sequences. The processing unit is configured to perform a first strategy and obtain a processing result of the to-be-processed data based on an obtained second shift result. The first strategy includes, based on a maximum shift number of a single shift operation supported by hardware, dividing the target shift numbers into a common shift number and individual shift numbers, performing addition after performing first-level shifting on the to-be-processed data with the plurality of individual shift numbers to obtain a first shift result, and performing second-level shifting on the first shift result according to the common shift number to obtain the second shift result.

An aspect of the present disclosure provides a non-transitory computer-readable storage medium storing a computer program that, when executed by one or more processors, causes the one or more processors to obtain to-be-processed data and a target weight, based on the target weight, obtain at least one target shift number, target shift numbers including all or a part of values of the valid value sequences, and perform a first strategy and obtaining a processing result of the to-be-processed data based on an obtained second shift result. The target weight includes a plurality of sets of valid number sequences, and after an initial weight is quantized into a sum of a plurality of powers of 2s, values of the sets of valid value sequences are power values of the plurality of powers of 2s. The first strategy includes, based on a maximum shift number of a single shift operation supported by hardware, dividing the target shift numbers into a common shift number and individual shift numbers, performing addition after performing first-level shifting on the to-be-processed data with the plurality of individual shift numbers to obtain a first shift result, and performing second-level shifting on the first shift result according to the common shift number to obtain the second shift result.

### BRIEF DESCRIPTION OF THE DRAWINGS

FIG. 1 illustrates a schematic flowchart of a data processing method according to some embodiments of the present disclosure.

FIG. 2 illustrates a schematic flowchart of another data processing method according to some embodiments of the present disclosure.

FIG. 3 illustrates a schematic flowchart of another data processing method according to some embodiments of the present disclosure.

FIG. 4 illustrates a schematic structural diagram of a data processing device according to some embodiments of the present disclosure.

FIG. 5 illustrates a schematic structural diagram showing a circuit corresponding to the data processing device according to some embodiments of the present disclosure.

FIG. 6 illustrates a schematic structural diagram showing another circuit corresponding to the data processing device according to some embodiments of the present disclosure.

FIG. 7 illustrates a schematic structural diagram showing another circuit corresponding to the data processing device according to some embodiments of the present disclosure.

### DETAILED DESCRIPTION OF THE EMBODIMENTS

The technical solutions of embodiments of the present disclosure are described in detail in connection with the accompanying drawings. The described embodiments are only a part of embodiments of the present disclosure, not all embodiments. Based on embodiments in the present disclosure, all other embodiments obtained by those of ordinary skills in the art without creative efforts should be within the scope of the present disclosure.

In the present disclosure, terms such as “first” and “second” are only used to distinguish one entity or operation from another entity or operation, without necessarily requiring or implying any actual relationship or order between these entities or operations. The term “comprising,” “including,” or any other variants is intended to cover non-exclusive inclusion, such that a process, method, article, or device that includes a list of elements is not limited to those elements but may include other elements not explicitly listed, or inherent elements of such a process, method, article, or device. Without further restrictions, an element defined by the phrase “comprising a . . . ” does not exclude the presence of other identical elements in the process, method, article, or device that includes the element.

The present disclosure can be used in various general-purpose or special-purpose computing device environments or configurations. For example, personal computers, server computers, handheld or portable devices, tablet devices, multiprocessor systems, distributed computing environments that include any of the above devices, etc.

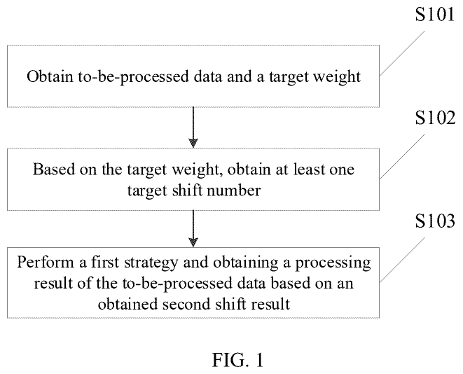

Embodiments of the present disclosure provide a data processing method. The method can be applied to various system platforms. The execution body of the method can be a processor of a computer terminal or various mobile equipment. FIG. 1 illustrates a schematic flowchart of the data processing method according to some embodiments of the present disclosure. The method includes the following processes.

At S101, to-be-processed data a target weight are obtained.

The target weight can include a plurality of sets of valid value sequences. The values of the sets of valid value sequences can include that the initial weight can be exponent values of powers of 2 based on a sum of a plurality of powers of 2. For example, the initial weight is 48-00110000, and the sum of the plurality of powers of 2 is 48=2⁵+2⁴. Based on the exponent values of 5 and 4, the target weight can be obtained as 0101100, where the valid value sequences in the target weight are 101 and 100, respectively.

The to-be-processed data can be feature data input into a neural network model or feature data that has been preprocessed after being input into the neural network model. In some embodiments, the to-be-processed data can be text data, image data, video data, or audio data.

Each set of valid value sequences in the target weight can be binary data. The to-be-processed data can be binary data corresponding to the feature data input into the neural network model.

In the present disclosure, the first bit of the bit positions in the target weight can be a sign bit, while the other bits can be value bits. The value bits can include a plurality of sets of valid value sequences.

The target weight can be obtained by processing the initial weight provided by the model training side and configured in the model when the network is deployed or can be transformed from the initial weight each time the model is used for further data processing. If the target weight is quantized and compressed during network deployment and configured into the model, the target weight can be directly applied during data processing using the neural network model to realize the data processing process of the neural network model. If the target weight is obtained by quantizing and compressing the initial weight each time the neural network model is used, the initial weight in the neural network model can be first quantized and compressed before using the neural network model to perform data processing, and after the target weight is obtained, the target weight can be used to realize the data processing process of the neural network model.

At S102, based on the target weight, at least one target shift number is obtained.

The target shift number can be values of all or a part of the valid value sequences in the target weight.

When the weight in the neural network model is used to process the to-be-processed data, the to-be-processed data can be processed once or a plurality of times. When the to-be-processed data needs to be processed once, the obtained target shift number can be the values of all valid value sequences in the target weight. When the to-be-processed data needs to be processed for a plurality of times, the values of the valid value sequences in the target weight can be divided into a plurality of value sets. When the to-be-processed data is processed according to the number of the divided sets, the values of the valid value sequences in the current value set can be the target shift number.

At S103, the first strategy is executed, and a processing result of the to-be-processed data is obtained based on an obtained second shift result.

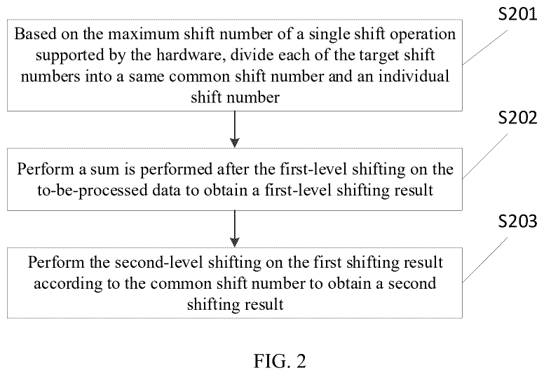

Executing the first strategy can primarily include performing shift processing on the to-be-processed data according to the target shift numbers. During the shifting process, the shifting results obtained by using the hardware for shifting can be asynchronous when a difference between a plurality of target shift numbers is too large. Thus, the target shift numbers can be divided first through the first strategy, and the shifting can be then performed. As shown in FIG. 2, the first strategy includes the following steps.

At S201, based on the maximum shift number of a single shift operation supported by the hardware, each of the target shift numbers can be divided into a same common shift number and an individual shift number.

The maximum shift number of the single shift operation supported by the hardware can be related to the bit number of the initial weight. If the bit number of the initial weight is 8 bit, the value range after the initial weight is quantized can range from −2⁷ to 2⁷. Thus, the maximum shift number of the single shift operation supported by the hardware can be not greater than 7. That is, the range of the maximum shift number can be [0, 7].

In the present disclosure, if any one of the target shift numbers is greater than the maximum shift number, each of the target shift numbers can be divided into the common shift number and the individual shift number. For example, the target shift numbers can be 3, 4, and 5, respectively. The maximum shift number of the single shift operation supported by the hardware can be 4. The common factor “3” can be extracted as the common shift number. The individual shift numbers corresponding to the target shift numbers can be 0, 1, and 2, respectively.

In hardware, multi-level shifting can be performed on the to-be-processed data according to the target shift numbers. For example, the hardware can support two-level shifting, if the bit number of the initial weight is 8 bit, a sum of the maximum shift number supported by the first-level shifting and the maximum shift number supported by the second-level shifting can be not smaller than number 7. If the maximum shifting number of the first-level shifting is greater than the maximum shifting number of the second-level shifting, the maximum shifting number of the second-level shifting can be the maximum shifting number of the single shift operation supported by the hardware. If the maximum shift number of the first-level shifting is smaller than the maximum shift number of the second-level shifting, the maximum shift number of the first-level shifting can be the maximum shift number of the single shift operation supported by the hardware.

For example, the maximum shift number supported by the first-level shifting can be 4, and the maximum shift number supported by the second-level shifting can be 7, the individual shift numbers in the first-level shifting cannot exceed 4. If any of the target shift numbers exceeds 4, the target shift numbers may need to be divided into common shift numbers and individual shift numbers. The individual shift numbers obtained after division can be not greater than 4, and the common shift number cannot be greater than 7.

For another example, the maximum shift number for the first-level shifting can be 4, and the maximum shift number for the second-level shifting can be 3. Then, the shift numbers of the first-level shifting cannot exceed 4, and the shift numbers of the second-level shifting cannot exceed 3. If any of the target shift numbers are greater than 3, the target shift numbers may need to be divided into a common shift number and individual shift numbers. The individual shift numbers may not exceed 4, and the common shift number may not exceed 3.

In some embodiments, the method of dividing the target shift numbers into the identical common shift number and the individual shift numbers can include at least one of the following methods.

On one hand, the smallest shift number of the target shift numbers can be used as the common shift number, and differences between the target shift numbers and the common shift number can be the individual shift numbers.

On another hand, according to the second-level shift number supported by the hardware, any one common value of the target shift numbers can be extracted as the common shift number, and the differences between the target shift numbers and the common shift number can be the individual shift numbers.

At S202, a sum is performed after the first-level shifting is performed on the to-be-processed data to obtain a first-level shifting result.

When the first-level shifting is performed according to the plurality of individual shift numbers, the shifting can be only performed on the value bit in the to-be-processed data. The to-be-processed data can be a binary number. In the bit positions of the binary number, the first bit can be a sign bit, and other bits can be value bits.

For example, if the to-be-processed data is 48=00110000. The first bit value “0” in the can indicate that the to-be-processed data is a positive value. If the individual shift numbers are 0, 1, and 2, respectively, the initial shift results obtained after performing the shifting on the to-be-processed data according to the individual shift numbers can be 0000000000110000, 0000000001100000, and 0000000011000000, respectively. Then, the sum can be performed on the three initial shift results to obtain the first shift result 0000000101010000.

Before the first-level shifting is performed on the to-be-processed data, since the bit number after the binary number is shifted may exceed the original bit number, the to-be-processed data can be expanded in advance. To expand the to-be-processed data, values same as the value of the sign bit can be added to the left of the to-be-processed data. For example, if the value of the sign is “0,” a plurality of bit positions with a value of “0” can be added to the left side of the to-be-processed data. If the value of the sign is “1,”, a plurality of bit positions with a value of “1” can be added to the left side of the to-be-processed data.

At S203, the second-level shifting is performed on the first shifting result according to the common shift number to obtain a second shifting result.

Based on the method above, performing the first-level shifting and the second-level shifting on the to-be-processed data can include the following embodiments.

For example, according to the example corresponding to step S202, if the common shift number is 3, after the first shift result of 0000000101010000 is obtained, shifting can be performed on the first shift result of 0000000101010000 to obtain the second shift result of 0000101010000000.

In some embodiments, if the target shift numbers are not greater than the maximum shift number of the single shift operation supported by the hardware, the target shift numbers may not need to be divided. The first-level shifting can be performed on the to-be-processed data according to the target shift numbers. In some other embodiments, the common shift number can be 0 after division, the individual shift numbers can be consistent with the target shift numbers.

In embodiments of the present disclosure, if the target shift numbers are all the values of all the valid value sequences in the target weight, the second shift result obtained after performing the first strategy can be the final processing result of the to-be-processed data. If the target shift numbers are a part of the values of the valid value sequences in the target weight, the first strategy can be performed a plurality of times according to the target shift numbers corresponding to the values of each part of valid value sequences, and addition can be performed on the second shift result obtained each time when the first strategy is performed to obtain the processing result corresponding to the to-be-processed data.

In some embodiments, shifting can be performed on the to-be-processed data according to the plurality of target shift numbers. For example, b can be a target weight, and b=2^{m}+2ⁿ. The target shift numbers can be m and n. If the to-be-processed data is a, the final shift result obtained by performing addition after shifting is performed on the to-be-processed data is calculated as follows.

$$a * b = a * ( {2}^{m} + {2}^{n} ) = a * {2}^{m} + a * {2}^{n} = a ≪ n + a ≪ m \qquad ( 1 )$$

where the symbol “«” denotes a shift sign.

Further, if any of the target shift numbers m or n is greater than the maximum shift number of the single shift operation supported by the hardware, the common factor can be extracted from the target shift numbers as the common shift number, and the values after the common factor is extracted can be treated as the individual shift numbers. For example, if n=k+i, and m=k+j, the formula (1) can be transformed into:

$$a * b = a * ( {2}^{n} + {2}^{m} ) = a * ( {2}^{k + i} + {2}^{k + j} \qquad ( 2 )$$

According to formula (2), the shift formula can be derived as:

$$a * b = a ≪ ( k + i ) + a ≪ ( k + j ) = ( a ≪ i ) ≪ k + a ( ≪ j ) ≪ k = ( a ≪ i + a ≪ j ) ≪ k \qquad ( 3 )$$

where k denotes the common shift number, and i and j denote the individual shift numbers.

The system can be optimized in a hierarchical manner. The shift operation can be performed in two steps. If the to-be-processed data needs to be shifted by 0 to 7 bits, the to-be-processed data can be divided into two shifting parts, i.e., first-level shifting and second-level shifting. For example, when the shift operation of the first-level shifting is performed, the to-be-processed data can be shifted for 0 to 4 bits. When the shift operation of the second-level shifting is performed, the to-be-processed data can be shifted for 0 to 3 bits. After dividing the shifting into two shift operations, the to-be-processed data can still be shifted for 0 to 7 bits.

Assume that the target shift numbers are 4 and 6, the method of dividing the target shift numbers to obtain the common shift number and the individual shift numbers is as follows.

Since the shift number of the second-level shifting in the hardware structure is 0 to 3, the common factor extracted should not be greater than 3. For example, the target shift numbers are 4 and 6, the common shift number of 3 can be extracted, and the two individual shift numbers can be 4−3=1 and 6−3=3.

Further, in the neural network model, the to-be-processed data and the target data can have negative values. Therefore, during data processing, besides performing shift processing on the to-be-processed data, sign processing can be further performed according to the sign of the to-be-processed data and the sign of the target weight to determine whether the sign bit of the processing result is positive or negative.

The to-be-processed data and the target weight can include the sign bit. When the sign bit has a value of 0, the sign can be “+.” When the sign bit has a value of 1, the sign can be “-.” The processing method for the sign can include performing a reversing operation on the value of the sign bit of the to-be-processed data and the value sequence formed by the values of the bit positions of the to-be-processed data and then adding by 1. The method can further include performing a logic operation on the result and the value of the sign bit of the target weight to obtain the sign result of the sign processing and adding the sign result with the second shift result to obtain the processing result of the to-be-processed data.

Further, before performing the shift processing on the to-be-processed data, the bit position number of the to-be-processed data can be expanded. According to the value of the sign bit of the to-be-processed data, a plurality of bit numbers with the value of the sign bit can be added to the left side of the to-be-processed data. After the sign processing is performed, the obtained sign result can be added with bits to cause the bit numbers of the sign result after adding the bits to be consistent with the bit numbers of the to-be-processed data.

In the present disclosure, the weight can be quantized to a finite number of powers of 2 (2ⁿ) to simplify the multiplication operation to a limited number of shifting and addition operations. Thus, the multiplication operation can be optimized. Meanwhile, by performing hierarchical shift processing, a common factor (a common shift number) can be extracted for a plurality of parallel paths. After the processing results of the plurality of paths are accumulated and combined, only one common factor operation can be performed on the combined result. In the present disclosure, the method for performing multi-level shifting can reduce the bit number of the shifting process. Thus, the hardware resource for performing the shifting processing can be simple, and a plurality of addition calculations may not be performed on the data to reduce the hardware resources for the adders.

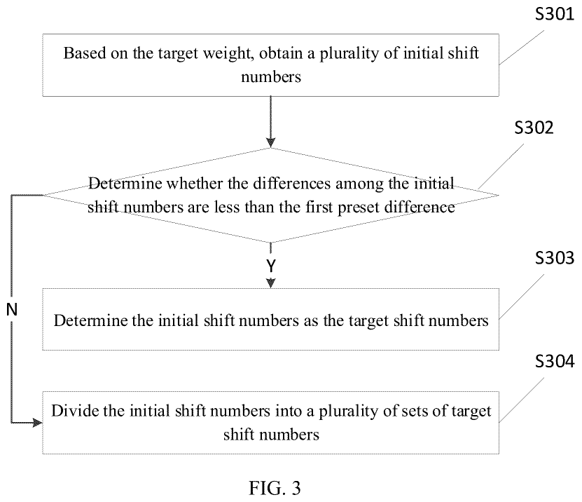

In embodiments of the present disclosure, as shown in FIG. 3, obtaining target shift numbers based on the target weight is as follows.

At S301, based on the target weight, a plurality of initial shift numbers are obtained.

The initial shift numbers can be the values of all the valid value sequences in the target weight.

For example, the initial weight can be quantized to be a=2²+2³+2⁵. The valid value sequences in the target weight can be a binary number corresponding to 2, a binary number corresponding to 3, and a binary number corresponding to 5. That is, the target weight can be a=0010011101, and the initial shift numbers can be 2, 3, and 5, respectively. The first bit 0 can be the sign bit, 010 can correspond to the initial shift number 2, 011 can correspond to the initial shift number 3, and 101 can correspond to the initial shift number 5.

At S302, whether the differences among the initial shift numbers are less than the first preset difference is determined.

If the differences among the initial shift numbers are less than the first preset difference, step S303 can be performed. If the differences among the initial shift numbers are not less than the first preset difference, step S304 can be performed.

The first preset difference may not be greater than the maximum shift number of the first-level shifting. A plurality of paths of executable first-level shifting can be arranged in the hardware. If the plurality of paths of first-level shifting need to be processed simultaneously, the differences among the shift numbers of the plurality of paths may need to be ensured to be smaller than the first preset difference. When the differences among the shift numbers are smaller, the first-level shifting of the plurality of paths can be completed almost simultaneously. At S303, the initial shift numbers are determined as the target shift numbers.

If the differences between the initial shift numbers are smaller than the first preset difference, the shifting can be performed with the initial shift numbers almost synchronously when the shift processing is performed.

At S304, the initial shift numbers are divided into a plurality of sets of target shift numbers.

In each set of target shift numbers, the differences among the target shift numbers can be smaller than the first preset difference.

After dividing the initial shift numbers into the plurality of sets of target shift numbers, the first strategy corresponding to steps S201 to S203 can be performed on the target shift numbers in each set of target shift numbers. If the first strategy needs to be performed for a plurality of rounds, the second shifting result obtained by each time performing the first strategy can be added together to obtain the processing result of the to-be-processed data.

For example, if the initial shift numbers corresponding to the target weight are 1, 2, 6, and 7, and the first preset value is 4, two initial shift numbers have a difference therebetween greater than the first preset value. Thus, the initial shift numbers can be divided into two sets of target shift numbers. A first set can include 1 and 2, and the second set can include 6 and 7. The first strategy can be performed for two rounds on the to-be-processed data according to the divided sets. The first round of the first strategy can be performed to divide the target shift numbers 1 and 2 into a common shift number 1 and individual shift numbers 0 and 1. Addition can be performed after performing the first-level shifting on the to-be-processed data according to the individual shift numbers 0 and 1 to obtain a first processing result. Then, according to the common shift number of 1, the second-level shifting can be performed on the first processing result to obtain a second processing result. The first strategy can be performed for the second round to divide the target shift numbers 6 and 7 into a common shift number 6 and individual shift numbers 0 and 1. Addition can be performed after performing the first-level shifting on the to-be-processed data according to the individual shift numbers 0 and 1 to obtain a first processing result. According to the common shift number 6, the second-level shifting can be performed on the first processing result to obtain a second processing result. Subsequently, the second processing results obtained by performing the two rounds of the first strategy can be added together to obtain the processing result of the to-be-processed data.

In some embodiments, before dividing the initial shift numbers, a number of target shift numbers for each round of the first strategy can be pre-determined. For example, the target shift numbers can be m, n, and k in an ascending order. A counter “number” can indicate how many components the first round of the first strategy can process. If number=1, only one component, i.e., m, can be processed in the first round. Then, n and k can be processed in the second round. If number=2, two components, i.e., m and n, can be processed in the first round. k can be processed in the second round. If number=3, all three components can be processed in the first round, and no second round is needed. To reduce hardware complexity, the value of “number” can be calculated in advance by a software and stored as a network parameter in memory, or can be calculated in real-time by the hardware during system operation.

In the method of embodiments of the present disclosure, the to-be-processed data and the target weight can be obtained, and according to the target weight, the values of each set of valid value sequence in the target weight can be obtained as the initial shift numbers. Whether the differences among the initial shift numbers are greater than the first preset value can be determined. If no, the initial shift numbers can be target shift numbers, and one round of first strategy can be performed. The second shift result obtained in the first strategy can be used as the processing result of the to-be-processed data. If yes, the initial shift numbers can be divided into a plurality of sets. The differences among each set of target shift numbers can be not greater than the first preset value. A plurality of rounds of first strategy can be performed according to the divided sets of target shift numbers. The second shift result obtained from each round of first strategy can be added to obtain the processing result of the to-be-processed data.

During the execution of the first strategy, the target shift numbers can be divided into a common shift number and individual shift numbers according to the maximum shift number of the single shift operation supported by the hardware. Then, the addition can be performed to obtain the first shift result. The second-level shifting can be performed on first shift result according to the common shift number to obtain the second shift result.

In embodiments of the present disclosure, the multiplication calculation between the to-be-processed data and the weights in the neural network model can be simplified through a plurality of shift operations. Meanwhile, during the shift operations, the plurality of shift numbers can be divided into a plurality of sets, and then, the multi-level shifting can be performed to reduce the complexity for the hardware to perform the shift operations. Thus, the method of performing a plurality of rounds of shifting can reduce the hardware resources.

The implementation processes and variations of embodiments of the present disclosure are within the scope of the present disclosure.

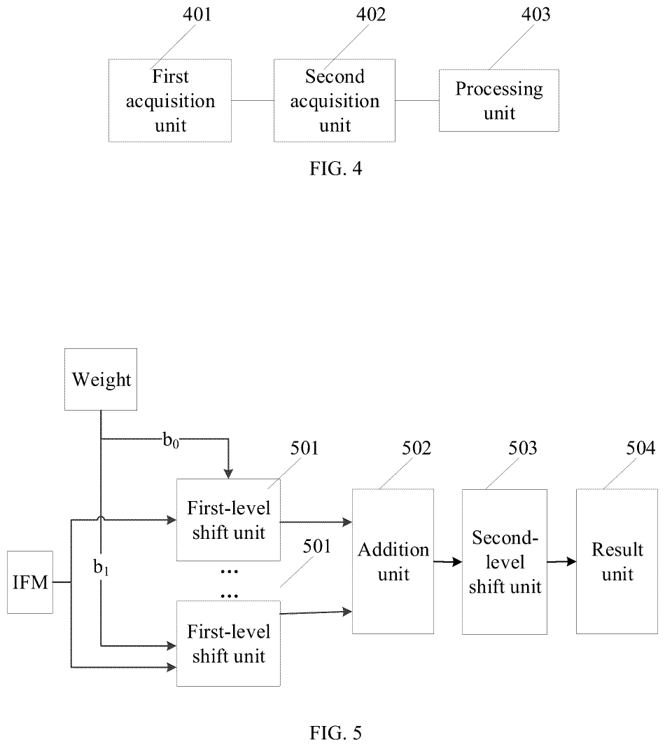

Corresponding to FIG. 1, embodiments of the present disclosure provide a data processing device configured to implement the method shown in FIG. 1. The data processing device of embodiments of the present disclosure can be applied to the computer terminal or various mobile equipment. FIG. 4 illustrates a schematic structural diagram of the data processing device according to some embodiments of the present disclosure. The device includes a first acquisition unit 401, a second acquisition unit 402, and a processing unit 403.

The first acquisition unit can be configured to obtain the to-be-processed data and the target weights. The target weights can include a plurality of sets of valid value sequences. The values of each set of valid value sequences can be the power values of 2 after the initial weights are quantized as a sum of a plurality of powers of 2.

The second acquisition unit 402 can be configured to obtain at least one target shift number based on the target weights. The target shift numbers can be all or a part of the values of the valid value sequences in the target weights.

The processing unit 403 can be configured to execute the first strategy and obtain the processing result of the to-be-processed data based on the obtained second shift result.

The first strategy can include, based on the maximum shift number of the single shift operation supported by the hardware, dividing the target shift numbers into the same common shift number and the individual shift numbers, performing addition after performing the first-level shifting on the to-be-processed data with the plurality of individual shift numbers to obtain the first shift result, and performing the second-level shifting on the first shift result according to the common shift number to obtain the second shift result.

In the device of embodiments of the present disclosure, as shown in FIG. 5, to-be-processed data (IFM) is shifted according to the shift numbers corresponding to the weight.

A processing unit 403 includes a plurality of first-level shift units 501, an addition unit 502, a second-level shift unit 503, and a result unit 504.

The plurality of first-level shift units 501 can be in a one-to-one correspondence with the individual shift numbers (e.g., b0 and b1 in FIG. 5) and can be configured to perform the first-level shifting on the to-be-processed data according to the individual shift numbers corresponding to the plurality of first-level shift units 501.

The addition unit 502 can be configured to perform addition on the results after the first-level shifting to output the first shift result.

The second-level shift unit 503 can be configured to perform the second level shifting on the first shift result according to the common shift number to output the second shift result.

The result unit 504 can be configured to output the processing result corresponding to the to-be-processed data according to the second shift result.

When the first strategy is performed, the processing unit 403 can use the smallest target shift number as the common shift number or use the common factor among the target shift numbers as the common shift number. The common shift number may not be greater than the maximum shift number supported by the second-level shift unit.

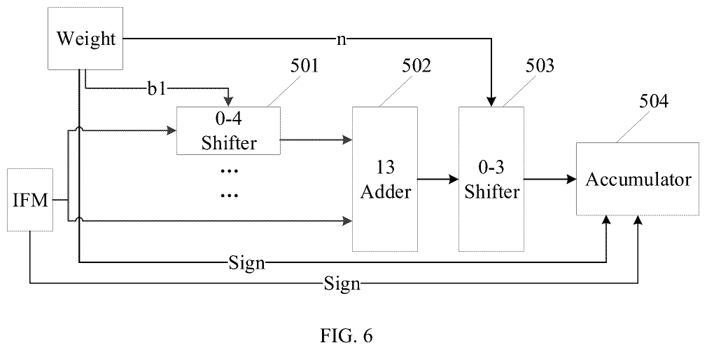

If the smallest target shift number is used as the common shift number, at least one individual shift number can be 0 among the individual shift numbers. As shown in FIG. 6, if the first-level shift unit 501 supports shifting from 0 to 4 bits (e.g., 0-4 shifter in FIG. 6), the second-level shift unit 503 supports shifting from 0 to 3 bits (e.g., 0-3 shifter in FIG. 6), and the target shift numbers can be 1 and 4, the value n=1 can be used as the common shift number, with the individual shift numbers of b0-0 and b1=3. Then, only one first-level shift unit 501 can be applied in the first shifting. The first-level shift unit 501 can be configured to shift the to-be-processed data 6 bits to the left. The addition unit (Add) 502 can be configured to add the result of the first-level shift unit 501 and the to-be-processed data without shifting to obtain the first shift result. The second shift unit 503 can be configured to perform the second-level shifting on the first shift result. Then, the result unit (Accumulator) 504 can be configured to output the processing result corresponding to the to-be-processed data according to the second shift result of the second-level shifting.

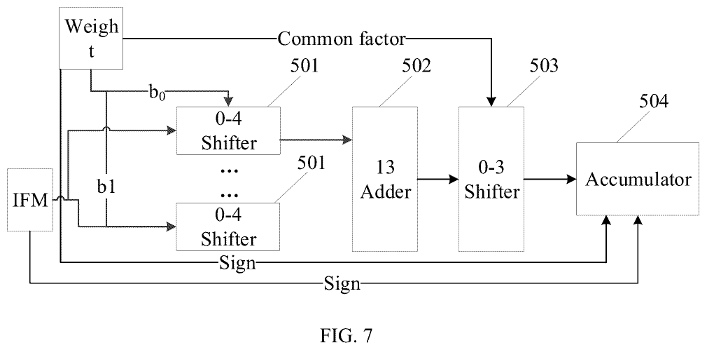

If the common factor is used as the common shift number, all the individual shift numbers can be greater than or equal to 0. As shown in FIG. 7, if the first-level shift unit supports shifting from 0 to 4 bits, the second-level shift unit supports shifting from 0 to 3 bits, and the target shift numbers are 4 and 6, the common factor value of 2 can be used as the common shift number, and the individual shift numbers can be b0=2 and b1=4. Then, two first-level shift units 501 are required to shift the to-be-processed data 2 bits to the left and 4 bits to the left, respectively. The addition unit 502 can add the results of the two times of shifting. Then, the second shift unit 503 can perform the second-level shifting on the result from the addition unit 502. Subsequently, the result unit 504 can output the processing result corresponding to the to-be-processed data according to the second shift result of the second-level shift unit.

In some embodiments, as shown in FIG. 6 and FIG. 7, when the first-level shifting and second-level shifting are performed on the to-be-processed data, since the wight for performing the shifting processing and the to-be-processed data are data with signs, the weight can be a positive or negative number, and the to-be-processed data can also be a positive or negative number. Thus, before processing the second shift result, the result unit can obtain the sign of the weight and the sign of the to-be-processed data, perform calculations on the signs to obtain the results of the signs, and add the results of the signs with the second processing result to obtain the processing result of the to-be-processed data.

Since the target shift numbers are divided into two times of shifting, the number of bits that the addition unit 502 needs to calculate can be relatively reduced. In the previous shifting process, taking int8 data as an example, if two pieces of int8 data need to be shifted, the maximum shift number for each time of shifting can be 7. Then, the addition unit 502 may need to process data of 16 bits. During the shifting process of the present disclosure, after the int8 is divided into two times of shifting, after the first-level shifting (the maximum shift number being a bit number smaller than 7, e.g., 4), the shift number of the first-level shifting can be relatively small. Then, the bit number needs to be processed by the addition unit 502 can be fewer (as shown in FIG. 6 and FIG. 7, the addition unit only needs to process data of 13 bits at maximal). Thus, the hardware resource can be further reduced.

For the operation processes of the units in the data processing device of embodiments of the present disclosure, reference can be made to the corresponding content of the data processing method of embodiments of the present disclosure, which are not limited here.

Embodiments of the present disclosure are described in a progressive manner. The same or similar parts among embodiments of the present disclosure can refer to each other. Each embodiment focuses on the differences from the others. In particular, since systems or system embodiments are similar to method embodiments, the descriptions are relatively simple. For the relevant parts, reference can be made to the descriptions of the method embodiments. The systems and system embodiments are merely illustrative. The units described as separate components may be or may not be physically separated. The units shown as modules may be or may not be physical units. That is, the units shown as modules can be located in one place or distributed across a plurality of network units. Some or all of the modules can be selected as needed to implement the purpose of embodiments of the present disclosure. Those skilled in the art can understand and implement embodiments of the present disclosure without creative effort.

Those skilled in the art can further recognize that the various units and algorithm steps described in embodiments of the present disclosure can be implemented by electronic hardware, computer software, or a combination thereof.

To describe the interchangeability between the hardware and the software, the components and steps of the examples are described according to general functionality. Whether these functions are performed by hardware or software depends on the specific application or design restrictions of the technical solution. Those skilled in the art can use different methods to realize the described function for each specific application, which should not be considered as exceeding the scope of the present disclosure.

The description of embodiments of the present disclosure can cause those skilled in the art to implement and use the present disclosure. Various modifications to embodiments of the present disclosure are obvious to those skilled in the art. The general principle defined in the present disclosure can be implemented in other embodiments without departing from the spirit or scope of the present disclosure. Thus, the present disclosure is not limited to embodiments of the present disclosure but should conform to the broadest scope consistent with the principles and novel features of the present disclosure.

What is claimed is:

1. A data processing method comprising:
obtaining to-be-processed data and a target weight, wherein the target weight includes a plurality of sets of valid number sequences, and after an initial weight is quantized into a sum of a plurality of powers of 2, values of the sets of valid value sequences are power values of the plurality of powers of 2;
based on the target weight, obtaining at least one target shift number, target shift numbers including all or a part of values of the valid value sequences; and
performing a first strategy and obtaining a processing result of the to-be-processed data based on an obtained second shift result;
wherein the first strategy includes:
based on a maximum shift number of a single shift operation supported by hardware, dividing the target shift numbers into a common shift number and individual shift numbers;
performing addition after performing first-level shifting on the to-be-processed data with the plurality of individual shift numbers to obtain a first shift result; and
performing second-level shifting on the first shift result according to the common shift number to obtain the second shift result.

2. The method according to claim 1, wherein a first bit of the target weight is a sign bit, and the other bits are numerical bits, and the numerical bits include the plurality of sets of valid value sequences.

3. The method according to claim 1, wherein obtaining the target shift number based on the target weight includes:
obtaining a plurality of initial shift numbers based on the target weight, the initial shift numbers corresponding to the value of all valid value sequences in the target weight;
determining differences among the initial shift numbers;
in response to the differences among the initial shift numbers being smaller than a first predetermined difference, determining the initial shift numbers as the target shift numbers; and
in response to the differences among the initial shift numbers being not smaller than the first predetermined difference, dividing the initial shift numbers into a plurality of target shift numbers, differences among target shift numbers of each set of target shift number being smaller than the first predetermined difference.

4. The method according to claim 3, wherein executing the first strategy includes:
in response to the initial shift numbers being divided into a plurality of sets of target shift numbers, performing a plurality of rounds of the first strategy.

5. The method according to claim 4, wherein obtaining the processing result of the to-be-processed data based on the obtained second shift result includes:
adding a second shift result obtained from each execution of the first strategy to obtain the processing result of the to-be-processed data.

6. The method according to claim 1, wherein the common shift number is smaller than or equal to the second-level shift number supported by the hardware.

7. The method according to claim 1, wherein the common shift number is a smallest shift number among the target shift numbers.

8. The method according to claim 1, wherein the independent shift numbers are not greater than a maximum shift number supported by the first-level shift, and the common shift number is no greater than the maximum shift number supported by the second-level shifting.

9. A data processing device comprising:
a first acquisition unit configured to obtain to-be-processed data and a target weight, wherein the target weight includes a plurality of sets of valid number sequences, and after an initial weight is quantized into a sum of a plurality of powers of 2, values of the sets of valid value sequences are power values of the plurality of powers of 2;
a second acquisition unit configured to, based on the target weight, obtain at least one target shift number, target shift numbers including all or a part of values of the valid value sequences; and
a processing unit configured to perform a first strategy and obtain a processing result of the to-be-processed data based on an obtained second shift result;
wherein the first strategy includes:
based on a maximum shift number of a single shift operation supported by hardware, dividing the target shift numbers into a common shift number and individual shift numbers;
performing addition after performing first-level shifting on the to-be-processed data with the plurality of individual shift numbers to obtain a first shift result; and
performing second-level shifting on the first shift result according to the common shift number to obtain the second shift result.

10. The device according to claim 9, wherein the processing unit includes:
a plurality of first-level shift units having a one-to-one correspondence with the individual shift numbers and configured to perform first-level shifting on the to-be-processed data according to the corresponding individual shift numbers corresponding to the plurality of first-level shift units;
an addition unit configured to add a result after the first-level shifting and output a first shift result;
a second-level shift unit configured to perform second-level shifting on the first shift result according to the common shift number and output a second shift result; and
a result unit configured to output the processing result of the to-be-processed data according to the second shift result.

11. The device according to claim 9, wherein a first bit of the target weight is a sign bit, and the other bits are numerical bits, and the numerical bits include the plurality of sets of valid value sequences.

12. The device according to claim 9, wherein the processing unit is further configured to:
obtain a plurality of initial shift numbers based on the target weight, the initial shift numbers corresponding to the value of all valid value sequences in the target weight;
determine differences among the initial shift numbers;
in response to the differences among the initial shift numbers being smaller than a first predetermined difference, determine the initial shift numbers as the target shift numbers; and
in response to the differences among the initial shift numbers being not smaller than the first predetermined difference, divide the initial shift numbers into a plurality of target shift numbers, differences among target shift numbers of each set of target shift number being smaller than the first predetermined difference.

13. The device according to claim 12, wherein the processing unit is further configured to:
in response to the initial shift numbers being divided into a plurality of sets of target shift numbers, perform a plurality of rounds of the first strategy.

14. The device according to claim 13, wherein the processing unit is further configured to:
add a second shift result obtained from each execution of the first strategy to obtain the processing result of the to-be-processed data.

15. The device according to claim 9, wherein the common shift number is smaller than or equal to the second-level shift number supported by the hardware.

16. The device according to claim 9, wherein the common shift number is a smallest shift number among the target shift numbers.

17. The device according to claim 9, wherein the independent shift numbers are not greater than a maximum shift number supported by the first-level shift, and the common shift number is no greater than the maximum shift number supported by the second-level shifting.

18. A non-transitory computer-readable storage medium storing a computer program that, when executed by one or more processors, causes the one or more processors to:
obtain to-be-processed data and a target weight, wherein the target weight includes a plurality of sets of valid number sequences, and after an initial weight is quantized into a sum of a plurality of powers of 2, values of the sets of valid value sequences are power values of the plurality of powers of 2;
based on the target weight, obtain at least one target shift number, target shift numbers including all or a part of values of the valid value sequences; and
perform a first strategy and obtaining a processing result of the to-be-processed data based on an obtained second shift result;
wherein the first strategy includes:
based on a maximum shift number of a single shift operation supported by hardware, dividing the target shift numbers into a common shift number and individual shift numbers;
performing addition after performing first-level shifting on the to-be-processed data with the plurality of individual shift numbers to obtain a first shift result; and
performing second-level shifting on the first shift result according to the common shift number to obtain the second shift result.

19. The storage medium according to claim 18, wherein a first bit of the target weight is a sign bit, and the other bits are numerical bits, and the numerical bits include the plurality of sets of valid value sequences.

20. The storage medium according to claim 19, wherein the one or more processors are further configured to:
obtain a plurality of initial shift numbers based on the target weight, the initial shift numbers corresponding to the value of all valid value sequences in the target weight;
determine differences among the initial shift numbers;
in response to the differences among the initial shift numbers being smaller than a first predetermined difference, determine the initial shift numbers as the target shift numbers; and
in response to the differences among the initial shift numbers being not smaller than the first predetermined difference, divide the initial shift numbers into a plurality of target shift numbers, differences among target shift numbers of each set of target shift number being smaller than the first predetermined difference.
